(19) United States
(12) Patent Application Publication
(10) Pub. No.: US 2005/0006311 A1
(43) Pub. Date: Jan. 13, 2005

(54) Automatic sensing of valid regeneration signal

(75) Inventor: Stephen Reif, Gages Lake, IL (US)

Correspondence Address: GREER, BURNS & CRAIN, 300 S WACKER DR, 25TH FLOOR, CHICAGO, IL, 60606, US

(73) Assignee: USF Consumer & Commercial WaterGroup, Inc.

(21) Appl. No.: 10/615,859

(22) Filed: Jul. 9, 2003

(51) Int. Cl. C02F 1/42

(52) U.S. Cl. 210/670; 210/85; 210/190

(57) ABSTRACT

A water softening method and corresponding apparatus in which a determination is made whether a valid regeneration in an operational cycle has occurred, including the steps of providing a reference cell in a water tank and a spaced sensing cell in the water tank, sensing the impedance difference of the solution in the water tank between the reference cell and the sensor cell, if the impedance difference is one of a first, a second and a third state, determining whether a maximum rinse timer has timed out, if the maximum rinse timer has timed out, determining whether the maximum time limit was a preset time period, if the preset time period was reached, then triggering an alarm signal indicating that a valid regeneration did not occur.

### BACKGROUND OF THE INVENTION

The present invention relates generally to water treatment devices such as water softeners, and particularly to a system for sensing when a valid regeneration has occurred in such a system.

Hard water causes problems such as scaling, spotting, soap scum, irritated/dry skin, poor laundry performance and others. Ion exchange water softeners are used to remove calcium and magnesium, commonly known as the “hardness” elements for the hard scale deposits they can cause. Softeners do this using the natural preferential exchange of sodium or potassium ions for those of the hardness elements. It is also possible to use this process for the removal of other troublesome multi-valent ions such as iron and manganese. Once the sodium ions have been exchanged off the resin by the hardness ions (given up their site to the more highly charged ions), the softener needs to have this naturally preferred process reversed. This process, conventionally referred to as regeneration, is accomplished by overcoming the naturally favored exchange by using a large excess of sodium ions in the form of a brine solution to drive the reaction the other way. As a constant flow of excess sodium ions moves through the ion exchange resin bed, the hardness elements are pushed off as waste along with the excess sodium. Finally, as the resin is rinsed, the resin exchange sites each hold one sodium ion. The equipment is then returned to service for the reduction of more hardness ions.

U.S. Pat. No. 5,699,272, incorporated by reference herein, discloses a system for electronically measuring the conductivity of an ion exchange bed in a water treatment system such as a water softener to determine when the resin bed is exhausted and in need of regeneration. The sensor also includes the ability of determining when the brine is rinsed out of the resin bed during the brine draw/slow rinse cycle.

In some applications, water softeners are used for meeting regulatory requirements such as the removal of radium from an influent water supply. Such a radium removal process will only be successful if the softener performs a valid regeneration, with all of the radium ions bonded to the resin beads being retained on the beads or otherwise removed from possible contamination with new influent/treated water. Current systems provide signals for alerting a control unit that the next step in the treatment process can begin. However, existing systems do not provide for a signal that indicates that a complete or valid regeneration has occurred.

Thus, there is a need for a water treatment system for use with a water softener and which provides an indication that a valid regeneration has occurred.

### BRIEF SUMMARY OF THE INVENTION

The above-listed needs are met or exceeded by the present system for indicating valid water softener regeneration, which features the incorporation of a measured time interval for the receipt of solution-induced signals. If the system fails to receive the solution-induced signals during a preset time period, then an alarm signal is generated for indicating that a valid regeneration did not occur. On the contrary, if the signals are properly received during the regeneration within the preset time period, a signal is generated to advance the treatment system to the next step. In addition, no alarm signal is generated, resulting in the lack of illumination of an alarm indicator, and/or the illumination of a “valid regeneration” indicator or the like.

More specifically, the present invention provides a water softening method in which a determination is made whether a valid regeneration in an operational cycle has occurred, including the steps of providing a reference cell in a water tank and a spaced sensing cell in the water tank, sensing the impedance difference of the solution in the water tank between the reference cell and the sensor cell, if the impedance difference is one of a first, a second and a third state, determining whether a maximum rinse timer has timed out, if the maximum rinse timer has timed out, determining whether the maximum time limit was a preset time period, if the preset time period was reached, then triggering an alarm signal indicating that a valid regeneration did not occur.

In another embodiment, the present system includes a water treatment apparatus in which a determination is made whether a valid regeneration has occurred, including a water tank, a brine tank, a conduit for providing brine from the brine tank to the water tank, a conduit for providing a path for water to discharge from the water tank, a reference cell in the water tank and a spaced sensing cell in the water tank. Also, a circuit is provided for sensing the impedance difference of the solution in the water tank between the reference cell and the sensor cell, and a microprocessor connected to the circuit for aiding in determining if the impedance difference is one of a first state, a second state and a third state, subsequently determining whether a maximum rinse time has been reached, if so, was an upper preset time limit reached, and if so triggering an alarm signal for alerting the user that a valid regeneration has not occurred.

### BRIEF DESCRIPTION OF THE SEVERAL VIEWS OF THE DRAWINGS

FIG. 1 is an elevational view of a water softening system of the type suitable for use with the present invention, with portions shown cut away for clarity;

FIG. 2; is a circuit and block diagram of a control circuit for the water softening system of FIG. 1; and

FIGS. 3a-3c are a flow chart showing the microprocessor-controlled self adjusting slow rinse subroutine of the present system.

### DETAILED DESCRIPTION OF THE INVENTION

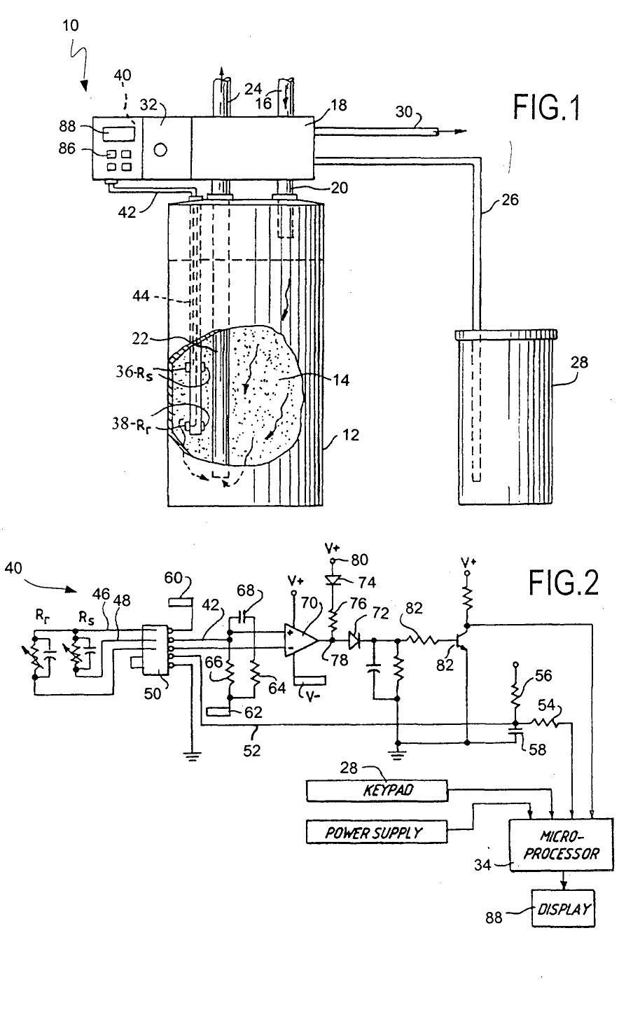

Referring to FIG. 1, a water conditioning or softening apparatus suitable for use with the present system is generally designated 10 and includes a water tank or main treatment tank 12 containing a bed 14 of suitable ion exchange resin. A water supply line 16 is connected via a valve housing 18 which passes the water through a pipe 20 extending into the tank 12. The water passes down through the bed 14 and is removed via a pipe 22 through the valve housing 18 to a line 24 which supplies the softened water to the water system. A conduit 26 extends from the valve housing 18 to a brine tank 28 which contains salt for forming the brine. A drain conduit 30 is also connected to the valve housing 18 and is connected to a suitable drain (not shown). A control unit 32 is mounted adjacent the valve housing for controlling the operation of the valve which diverts water as desired during operation of the softener 10. As is typical in such control units, a microprocessor 34 (best seen in FIG. 2) is included in the control unit 32.

As is well known in the art, the softener 10 operates most of the time in a service cycle, in which feed water flows through the resin bed 14 and is softened. Softened water is emitted out the line 24. At a preset time interval, set by the user based on consumption rates, hardness of feed water, and other factors known to those skilled in the art, the resin bed 14 must be regenerated to replace the hardness ions collected on the resin beads with sodium ions. First, a backwash step is conducted, in which feed water enters the tank 12 in reverse direction to flush out large particles and to loosen the resin bed 14 so that it is not overly compacted.

The next step is brine/draw and brine/rinse. This step has two functions. The first is to introduce brine into the treatment tank 12 from the brine tank 28 via the conduit 26. Brine is drawn into the treatment tank 12 for a number of minutes until a control valve (not shown, but well known in the art) in the brine tank 28 discontinues the brine draw. At that time, a slow rinse cycle begins. During the brine draw step, the resin bed 14 of the water softener 10 is surrounded totally by sodium ions. As hard water used in the slow rinse enters the tank through the conduit 16, it starts to form a low sodium/high sodium front at the top of the tank 12. This front will gradually advance downward towards the bottom of the tank 10 and end. As is described in commonly assigned U.S. Pat. No. 5,699,272, incorporated by reference herein, pairs of sensing and reference electrodes 36, 38, connected to the microprocessor 34, can be used to monitor the progress of the front towards the bottom of the tank 12. The electrode pairs 36, 38 are vertically spaced relative to each other for detecting the impedance difference of the solution in the water tank between the electrodes 36 which form a sensing cell Rs and the electrodes 38 which form a reference cell Rr. The monitoring of this front is preferably used to determine when the slow rinse cycle has concluded. It will also be noted that the electrodes 38 are in close operational proximity to a lower end of the conduit 22, through which flows both treated water and water intended for the drain through conduit 30, depending on the position of the valve in the valve housing 18. Upon conclusion of the slow rinse cycle, the softener 10 returns to the service cycle.

Referring now to FIG. 2, the circuit for controlling the cycles is generally designated 40, includes the microprocessor 34, and the electrodes 36, 38 are connected to the circuit 40 by lines 42. The reference cell Rr, and the spaced sensing cell Rs, both of which are carried by a probe 44 (FIG. 1) are connected via lines 46, 48 and to pins 1, 2 and 3 of a plug 50. Pin 4 is connected to the microprocessor 34 via a line 52 with a resistor 54 present to prevent the microprocessor 34 from any latchup condition. A resistor 56 and capacitor 58 operate as an indicator to indicate to microprocessor 34 that the probe 44 is present (i.e., it has been plugged in) and this provides the appropriate signal to the microprocessor. When the probe 44 is not plugged in there will be a 5 volt signal and when the probe is plugged in the pins 4 and 5 of plug 50 will be shorted so that will be a zero volt signal.

Reference cell Rr forms one arm of a Wheatstone bridge circuit. Sensing cell Rs forms another arm of the Wheatstone bridge circuit. The probe is excited with an AC voltage across points 60 and 62. The AC voltage prevents scaling in that if a DC voltage were used; scaling could be present on the cells Rr and Rs. Resistor 64 forms another arm of the Wheatstone bridge and resistor 66 forms the fourth arm of the Wheatstone bridge. Capacitor 68 is used as a filter capacitor to prevent RF noise from affecting the circuit or false signals. The output of the Wheatstone bridge is connected to a comparator 70, the output of which is an open collector device that can be either off or on depending on whether the probe is in balance or out of balance. Comparator 70 itself has an internal transistor. When the comparator 70 is off, the output of the comparator is a half-wave rectified signal resembling a trapezoid signal. When the comparator 70 is on, the output of the comparator is a DC voltage.

Thus, when the comparator 70 is off, there is a DC voltage at the output of a diode 72 and when the comparator is on, the output of the diode 72 is at ground. When the comparator 70 is on, the cells Rr and Rs are balanced and when the comparator is off the cells are unbalanced. At states 1 and 3, the comparator is on and at state 2 the comparator is off.

A diode 74 and a resistor 76 are connected in series to a point 78 between the output of the comparator 70 and the anode of the diode 72. The phase relationship at a point 80 is critical to the phase relationship of the AC signal at the points 60 and 62.

The output of the diode 72 is coupled through a resistor 82 to an NPN transistor 84. The transistor 84 operates to turn the DC voltage at the output of the diode 72 into a zero to 5 DC volt signal for the microprocessor 34. Also, a keypad 86 is provided to the control unit 32 for permitting user input of time and calendar data as is known in the art. In addition, a display 88 is provided, such as but not restricted to an LCD display, which is connected to the microprocessor 34 for displaying the operational condition of the system 10.

Thus the circuit of FIG. 2 operates to determine whether the probe 44 with cells Rr, and Rs, is balanced or unbalanced. In the first stage, the probe 44 is balanced, in the second stage the probe is unbalanced; and in the third stage the probe is balanced again.

As is known in the art, a determination is made whether the regeneration is armed based on the impedance difference of the solution in the water tank between the reference cell Rr and the sensing cell Rs. If the regeneration is armed, a determination is made as to whether it is the time of day for regeneration to occur, such as between 2:00 am and 6:00 am. If it is regeneration time, then regeneration is started and a motor in the control unit 32 is turned on. Next, a determination is made whether the motor is at backwash, and if so, then a backwash time is loaded. Backwash will continue until the timer is timed out. Once the timer times out, the motor is turned on and a determination is made whether the motor is at brine draw/slow rinse. Next, a determination is made whether the probe 44 is attached, and if so a self-adjusting slow rinse subroutine is called.

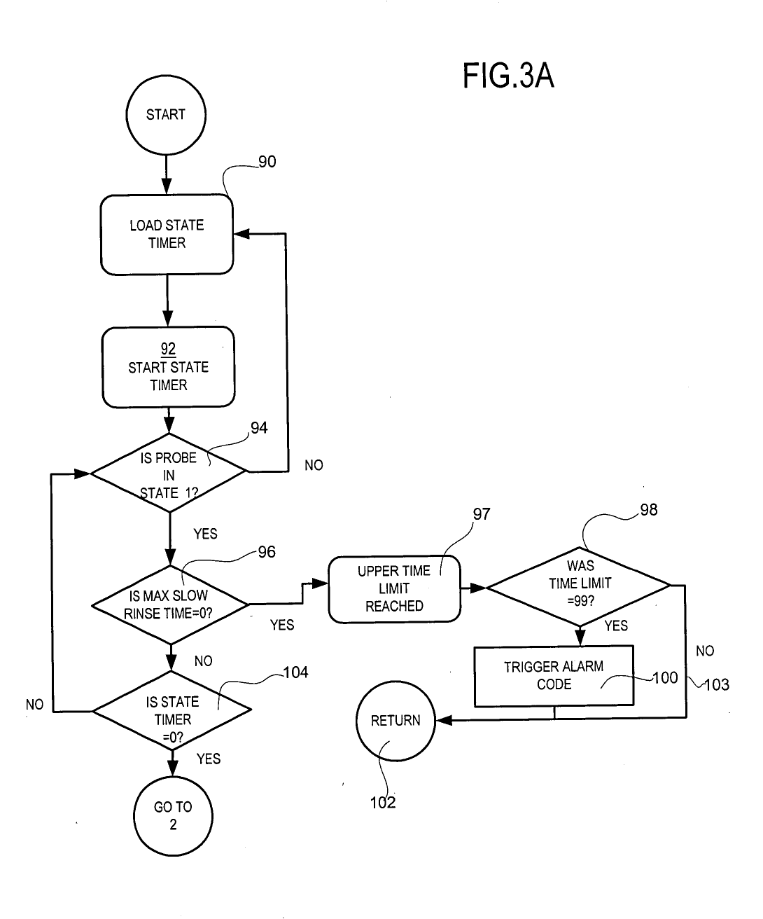

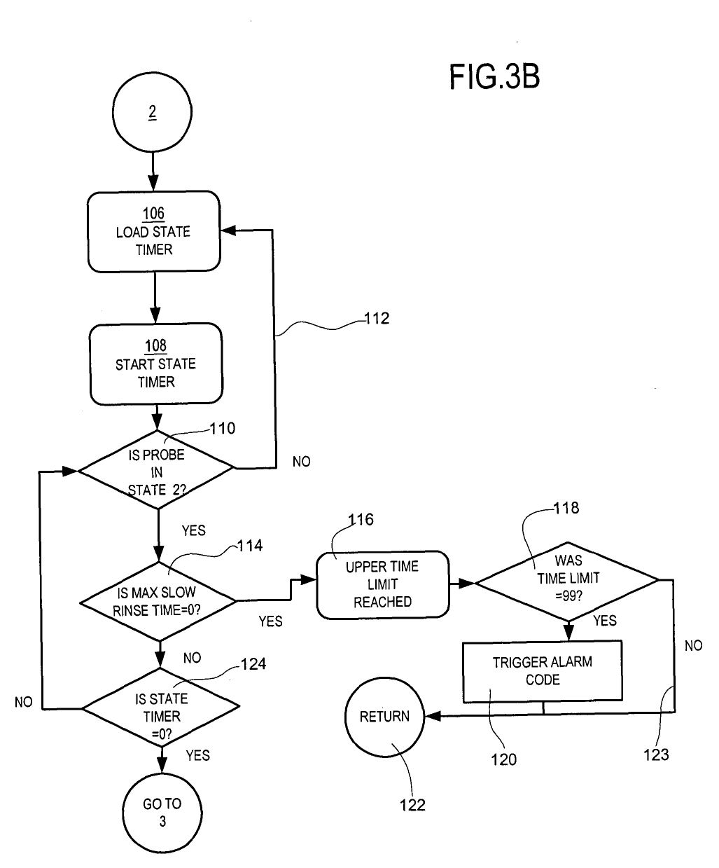

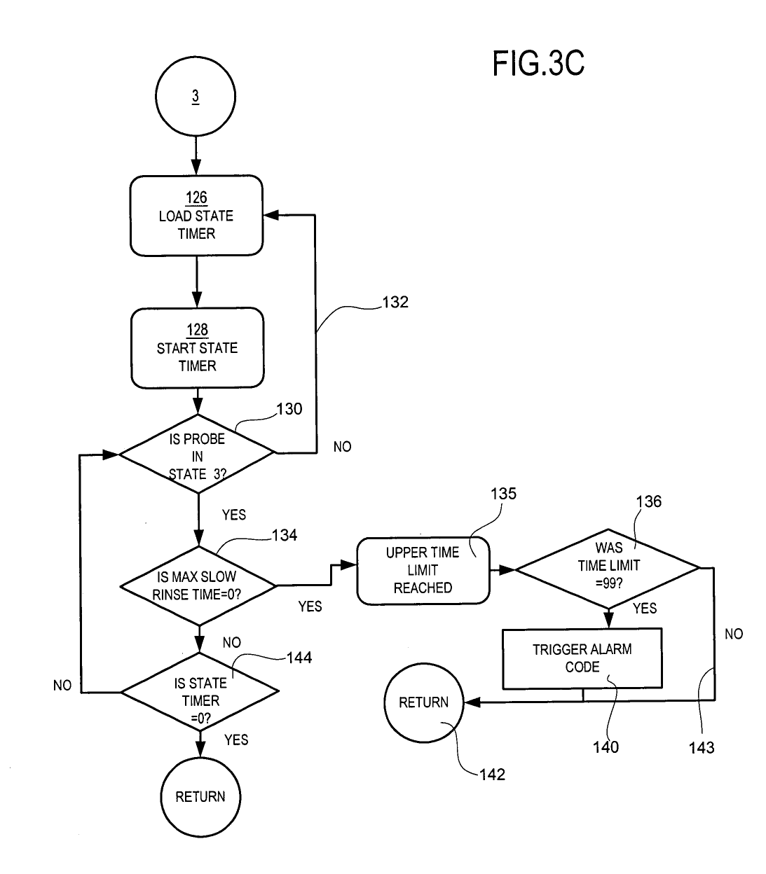

Referring to FIGS. 3a-3c, a flowchart of the self-adjusting slow rinse subroutine is illustrated. First, when the motor associated with the main control valve is at brine draw/slow rinse, a maximum slow rinse timer is loaded in the microprocessor 36. This timer can be loaded with, for example, 99 minutes (a longer time than the entire cycle should take) so that if the maximum slow rinse timer times out and this upper time limit of 99 minutes is reached, the system triggers an alarm mode, indicating that there is an aberration.

A state timer is loaded (90) and started (92). A determination is made whether the probe 44 is in state 1 (94). If the probe 44 is not in state 1, the state timer is reloaded (90) and it continues to be reloaded until a determination is made that the probe is in state 1. Once the determination is made that the probe 44 is in state 1, a determination is made whether the maximum slow rinse timer has timed out (96). If it has timed out, or the answer is yes (meaning the upper time limit (here 99 minutes) has been reached, at (97), a determination is made whether the time limit was 99 minutes (98). If the time limit was 99 minutes, an alarm code is triggered (100). While the present embodiment employs 99 minutes as an alarm trigger point, it is to be understood that other times may be selected, depending on the application. This code may take the form of a visual signal such as a legend on the display 88, an LED on the display or elsewhere becoming illuminated, a dual color LED going from one color to the next (green to red), a constantly visible LED beginning to flash, an audible signal (constant or intermittent) or equivalent alarm signals, including combinations of the above. The triggering of the alarm at 100 means that a valid regeneration did not occur, and that the effluent water may no longer be in compliance with accepted standards. The cycle is discontinued at 102 because there is a problem. If the time limit was not 99, the alarm signal is not triggered but the cycle is still discontinued (103).

If the upper time limit (in this example 99 minutes) has not been reached, a determination is made whether the state timer has timed out (104). In the illustrative embodiment (although no limitation is intended), the state timer for state 1 may be five minutes. Thus once five minutes has expired since the probe is in state 1, the state timer is loaded for the state 2 time (106) (FIG. 3b) and the state timer is started (108). A determination is made if the probe 44 is in state 2 (110). So long as the probe 44 is not in state 2, the state timer is reloaded (112) until the probe is in state 2.

Once the probe 44 is in state 2, a determination is made whether the maximum slow rinse timer has timed out (114) and if it has timed out and the upper time limit has been reached (116). Next, it is determined whether the time limit was 99 minutes (118). If the time limit was 99 minutes, an alarm code is triggered (120). In the preferred embodiment, the alarm signal 120 is the same as the alarm signal 100; however distinct alarm signals for each step are contemplated. The cycle is discontinued (122), indicating that there is a problem. If the time limit was not 99 minutes, the cycle is still discontinued, but without the alarm (123). While the present embodiment employs 99 minutes as an alarm trigger point, it is to be understood that other times may be selected, depending on the application.

If the upper time limit has not been reached, a determination is made whether the state timer has timed out (124). If the state timer has timed out the state timer is loaded with the time for state 3 (126). In the illustrative embodiment, the state 2 time is preferably about five minutes although no limitation is intended.

Referring now to FIG. 3c, the state timer is loaded (126) and started (128) and a determination is made if the probe is in state 3 (130). So long as the probe is not in state 3, the state timer is reloaded (132). Once the probe is in state 3, a determination is made if the maximum slow time timer has timed out (134) and if so, it is determined whether the upper time limit was reached (135) and whether the time limit was 99 minutes (136). While the present embodiment employs 99 minutes as an alarm trigger point, it is to be understood that other times may be selected, depending on the application. If the time limit was 99 minutes, an alarm code is triggered (140) and the cycle is discontinued (142) indicating a problem. If the time limit was not 99 minutes, the cycle is still discontinued (143), but without the alarm.

So long as the upper time limit has not been reached, a determination is made whether the state timer has timed out (144). If the state timer has timed out, this indicated that state 3 has been completed and then the motor in the control unit 32 will be turned on, and a determination will be made if the motor is at a fast rinse position. In the illustrative embodiment, the timer for the third state is set to 15 minutes although no limitation is intended.

It is to be understood that the particular times set forth above can be varied and not limitation is intended by the specific times set forth herein. Further, flip flops or equivalent components could be utilized so that the first state could be an unbalanced state, the second state could be a balanced stated, and the third state an unbalanced state. Another alternative is that instead of determining whether the probe is in a particular state and reloading the state timer if not in the particular state, the state timer could be loaded and then not started until the determination is made that the probe is in the particular state.

After the slow rinse subroutine is performed, the motor is turned on and a determination is made whether the motor is in the fast rinse position. If so, the motor is turned off and the fast rinse time is loaded into the timer. When the fast rinse timer times out, the motor is turned on and a determination is made whether the motor is at a home position. If the motor is at home position, the motor is turned off and the regeneration is complete.

Thus, it will be seen that the present system provides for an indication whether a valid regeneration has occurred. Once the alarm signal is triggered, the user is alerted to the fact that the regeneration is not valid, which means that noncompliant effluent water is being dispensed.

While a particular embodiment of the present system for determining whether a valid regeneration has occurred has been described herein, it will be appreciated by those skilled in the art that changes and modifications may be made thereto without departing from the invention in its broader aspects and as set forth in the following claims.

1. A water softening method in which a determination is made whether a valid regeneration in an operational cycle has occurred, which comprises the steps of:
providing a reference cell in a water tank and a spaced sensing cell in said water tank;
sensing the impedance difference of the solution in the water tank between the reference cell and the sensor cell;
if the impedance difference is one of a first, a second and a third state, determining whether a maximum rinse timer has timed out;
if the maximum rinse timer has timed out, determining whether the maximum time limit was a preset time period;
if the preset time period was reached, then triggering an alarm signal indicating that a valid regeneration did not occur.

2. The method of claim 1 further including the step that if the preset rinse time period was reached, discontinuing the operational cycle.

3. The method of claim 1, further including the step that if the preset rinse time period was not reached, discontinuing the operational cycle.

4. The method of claim 1, wherein the preset rinse time period is 99 minutes.

5. The method of claim 1 wherein said alarm signal is at least one of an audible and a visual alarm indicator.

6. The method of claim 1 further including after determining that the maximum timer timed out, determining whether the maximum time limit was reached.

7. The method of claim 6, wherein the preset maximum time period is 99 minutes.

8. The method of claim 1 further including making the determination of whether the maximum preset time limit was the preset time limit separately for each of said first, second and third states.

9. A water softening method in which a determination is made whether a valid regeneration in an operational cycle has occurred, which comprises the steps of:
providing a reference cell in a water tank and a spaced sensing cell in said water tank;
sensing the impedance difference of the solution in the water tank between the reference cell and the sensor cell;
sequentially determining whether the impedance difference is one of a first, a second and a third state;
for each said state, determining whether a maximum rinse timer has timed out;
if the maximum rinse timer has timed out, determining whether the maximum time limit was a preset time period;
if the preset time period was reached, then triggering an alarm signal indicating that a valid regeneration did not occur; and
if the alarm signal is triggered, discontinuing the operational cycle.

10. A water treatment apparatus in which a determination is made whether a valid regeneration has occurred, said apparatus comprising:
a water tank;
a brine tank;
a conduit for providing brine from said brine tank to said water tank;
a conduit for providing a path for water to discharge from said water tank;
a reference cell in said water tank;
a spaced sensing cell in said water tank;
a circuit for sensing the impedance difference of the solution in said water tank between said reference cell and said sensor cell;
a microprocessor connected to said circuit for aiding in determining if the impedance difference is one of a first state, a second state and a third state, subsequently determining whether a maximum rinse time has been reached, if so, was an upper preset time limit reached, and if so triggering an alarm signal for alerting the user that a valid regeneration has not occurred.

11. The system of claim 10 wherein further including a display connected to said microprocessor for indicating said alarm signal.

12. The system of claim 10 wherein said alarm signal is at least one of audible and visual.
